(19) United States
(12) Patent Application Publication
(10) Pub. No.: US 2023/0249679 A1
(43) Pub. Date: Aug. 10, 2023

(54) DRIVER ASSISTANCE DEVICE, METHOD, NON-TRANSITORY STORAGE MEDIUM, AND VEHICLE

(71) Applicant: TOYOTA JIDOSHA KABUSHIKI KAISHA, Toyota-shi (JP)

(72) Inventors: Quy Hung NGUYEN VAN, Shizuoka-ken (JP); Shouji ITOU, Mishima-shi (JP); Akira HATTORI, Shizuoka-ken (JP)

(21) Appl. No.: 18/164,760

(22) Filed: Feb. 6, 2023

(30) Foreign Application Priority Data
Feb. 10, 2022 (JP) 2022-019732

(51) Int. Cl. B60W 30/095; B60W 40/08; B60W 30/09; B60W 50/14

(52) U.S. Cl. CPC B60W 30/095; B60W 40/08; B60W 30/09; B60W 50/14; B60W 2540/229; B60W 2540/225; B60W 2554/80; B60W 2540/18

(57) ABSTRACT

A driver assistance device for a vehicle, the driver assistance device includes one or more processors configured to: compute a perceptual risk estimate value indicating a characteristic of driving operations of a driver of a vehicle when the vehicle nears a target present in a direction of travel of the vehicle and the driver performs deceleration; decide a driver assistance method to be applied to the driver based on the perceptual risk estimate value that is computed; and execute the driver assistance method that is decided.

### CROSS-REFERENCE TO RELATED APPLICATION

This application claims priority to Japanese Patent Application No. 2022-019732 filed on Feb. 10, 2022, incorporated herein by reference in its entirety.

### BACKGROUND

### 1. Technical Field

The present disclosure relates to a driver assistance device, a method, a non-transitory storage medium, and a vehicle.

### 2. Description of Related Art

Japanese Unexamined Patent Application Publication No. 2015-130069 (JP 2015-130069 A) discloses a driver assistance device that decides a timing for providing assistance for avoiding a collision between a target that is present ahead of a vehicle and the vehicle, in accordance with lateral distance and distance-to-collision, based on tendencies in driving operations of a driver of the vehicle.

### SUMMARY

In driver assistance technology for a driver of a vehicle to avoid collision with a target such as another vehicle traveling ahead of the vehicle, there is demand for providing assistance that is appropriate for the driver according to driving characteristics of the driver.

The present disclosure provides a driver assistance device and so forth that are capable of carrying out driver assistance of an appropriate content, in accordance with driving characteristics of a driver of a vehicle.

A first aspect of the technology according to the present disclosure is a driver assistance device for a vehicle. The driver assistance device for a vehicle, the driver assistance device includes one or more processors configured to: compute a perceptual risk estimate value indicating a characteristic of driving operations of a driver of the vehicle when the vehicle nears a target present in a direction of travel of the vehicle and the driver performs deceleration; decide a driver assistance method to be applied to the driver based on the perceptual risk estimate value that is computed; and execute the driver assistance method that is decided.

A second aspect of the technology according to the present disclosure is a method executed by a computer of a driver assistance device of a vehicle, the method comprising: computing a perceptual risk estimate value indicating characteristic of driving operations of a driver of the vehicle when the vehicle nears a target present in a direction of travel of the vehicle and the driver performs deceleration; deciding a driver assistance method to be applied to the driver based on the perceptual risk estimate value; and executing the driver assistance method.

A third aspect of the technology according to the present disclosure is a non-transitory storage medium storing instructions that are executable by one or more processors and that cause the one or more processors to perform functions comprising: computing a perceptual risk estimate value indicating characteristic of driving operations of a driver of a vehicle when the vehicle nears a target present in a direction of travel of the vehicle and the driver performs deceleration; deciding a driver assistance method to be applied to the driver based on the perceptual risk estimate value; and executing the driver assistance method.

The driver assistance device and so forth according to the present disclosure that are described above are capable of providing driver assistance of an appropriate content, in accordance with driving characteristics of the driver of the vehicle.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic configuration diagram of a vehicle system including a driver assistance device according to an embodiment;

FIG. 2 is a flowchart of data collection learning processing executed by the driver assistance device;

FIG. 3 is a diagram illustrating an example of a relation between a distance and a speed of a vehicle traveling ahead and an own vehicle;

FIG. 4 is a flowchart of driver assistance processing executed by the driver assistance device; and

FIG. 5 is an example of driver assistance content based on a perceptual risk estimate value (PRE value).

### DETAILED DESCRIPTION OF EMBODIMENTS

In a situation in which another vehicle (hereinafter referred to as “vehicle traveling ahead”) is present in a direction of travel of a vehicle that is an object of assistance control (hereinafter referred to as “own vehicle” when necessary to distinguish from other vehicles), a driver assistance device according to the present disclosure carries out steering assistance and deceleration assistance, based on a speed perception and a distance perception of a driver of the own vehicle, which have been learned so far. This enables providing driver assistance that is appropriate for the driving characteristics of the driver of the vehicle and that also prioritizes safety.

An embodiment of the present disclosure will be described below in detail with reference to the drawings.

### EMBODIMENT

Configuration

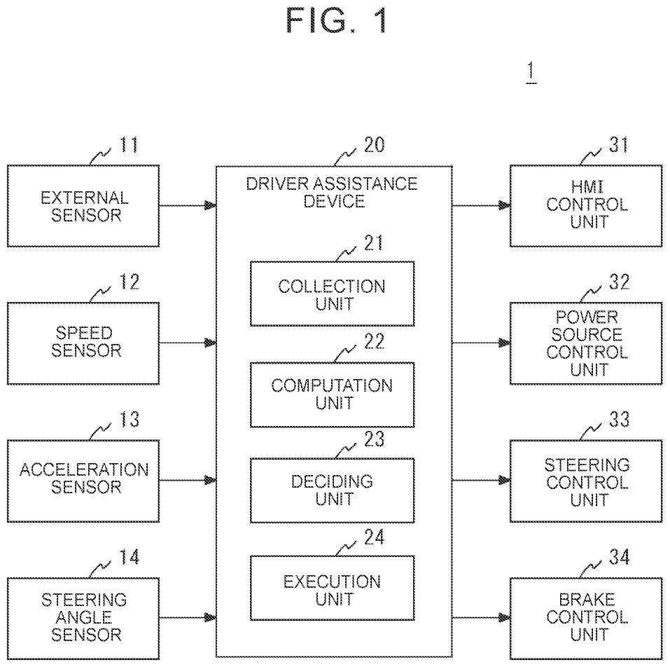

FIG. 1 is a diagram illustrating a schematic configuration of a vehicle system including a driver assistance device 20 according to an embodiment of the present disclosure. The vehicle system 1 illustrated in FIG. 1 includes an external sensor 11, a speed sensor 12, an acceleration sensor 13, a steering angle sensor 14, the driver assistance device 20, a human-machine interface (HMI) control unit 31, a power source control unit 32, a steering control unit 33, and a brake control unit 34. The vehicle system 1 can be installed in a vehicle such as an automobile or the like.

The external sensor 11 is a sensor for detecting/acquiring information relating to the surroundings of the vehicle. Specifically, the external sensor 11 is installed in a front portion of the vehicle, detects targets such as vehicles traveling ahead, two-wheeled vehicles, and so forth, that are present primarily in the surroundings ahead of the vehicle, and acquires information (type, speed, distance, and so forth) of the detected targets. Examples that can be used as the external sensor 11 include a radar sensor using laser, millimeter waves, microwaves, or ultrasonic waves, a camera sensor using a charge coupled device (CCD) or a complementary metal oxide semiconductor (CMOS), and so forth. Information regarding the surroundings of the vehicle (information regarding targets and so forth) that has been detected/acquired by the external sensor 11 is output to the driver assistance device 20.

The speed sensor 12 is a sensor for detecting/acquiring the speed of the vehicle. Examples that can be used as the speed sensor 12 include wheel speed sensors that are for detecting rotation speed (or rotation amount) of wheels and that are installed on each of the wheels of the vehicle. The speed of the vehicle detected/acquired by the speed sensor is output to the driver assistance device 20 as information regarding the vehicle.

The acceleration sensor 13 is a sensor for detecting/acquiring magnitude of acceleration (G-force) that the vehicle is subjected to. For example, a triaxial accelerometer, installed at a predetermined position of the vehicle to detect acceleration in a front-rear direction, a vehicle-width direction, and an up-down direction, of the vehicle, can be used as the acceleration sensor 13. The information regarding acceleration detected/acquired by the acceleration sensor 13 is output to the driver assistance device 20 as information regarding the vehicle.

The steering angle sensor 14 is a sensor for detecting/acquiring the steering angle of the steering wheel in accordance with steering operations of the driver of the vehicle. The steering angle sensor 14 is installed in, for example, the steering control unit 33 of the vehicle. The information regarding the steering angle of the steering wheel detected/acquired by the steering angle sensor 14 is output to the driver assistance device 20 as information regarding the vehicle.

The HMI control unit 31 is means capable of controlling presentation of information, such as the operating state of driver assistance, to the driver of the vehicle in accordance with instructions output from the driver assistance device 20. Various types of devices (omitted from illustration) such as a head-up display (HUD), a navigation system monitor, an instrument panel, speakers, and so forth, are used for presentation of information.

The power source control unit 32 is means capable of controlling actuators (omitted from illustration) as power sources of the vehicle, such as an internal combustion engine or a traction motor, for example, in accordance with instructions output from the driver assistance device 20 to control driving force and braking force generated by each of these power sources.

The steering control unit 33 is means capable of controlling force for assisting steering of the vehicle by, for example, an electric power steering mechanism (omitted from illustration) in accordance with instructions output from the driver assistance device 20.

The brake control unit 34 is means capable of controlling the braking force generated at the wheels via a brake device of the vehicle, for example, by an electric brake mechanism (omitted from illustration) in accordance with instructions output from the driver assistance device 20.

Based on the information regarding the vehicle and the information regarding the surroundings of the vehicle (information regarding targets and so forth) obtained from the external sensor 11, the speed sensor 12, the acceleration sensor 13, the steering angle sensor 14, and so forth, the driver assistance device 20 issues control instructions to the HMI control unit 31, the power source control unit 32, the steering control unit 33, and the brake control unit 34, so as to carry out suitable driver assistance to the driver of the vehicle.

The driver assistance device 20 may typically be configured as a part or all of an electronic control unit (ECU) including a processor, memory, an input/output interface, and so forth. The driver assistance device 20 of the present embodiment realizes the functions of a collection unit 21, a computation unit 22, a deciding unit 23, and an execution unit 24, which will be described below, by the processor reading and executing programs stored in the memory.

The collection unit 21 collects traveling data including information regarding the vehicle and information regarding the surroundings of the vehicle (information regarding targets and so forth) necessary for driver assistance, from the external sensor 11, the speed sensor 12, the acceleration sensor 13, the steering angle sensor 14, and so forth. Details of the traveling data will be described later. The computation unit 22 learns contents of driving operations (driving characteristics, driving perceptions) of the driver of the vehicle, and computes a perceptual risk estimate (PRE) in which learning results regarding the front-rear direction of the vehicle are reflected. This perceptual risk estimate (PRE) is a quantified characteristic of driving operations when the own vehicle nears a vehicle traveling ahead, and the driver decelerates to avoid contact therewith. Details of this perceptual risk estimate (PRE) will be described later. The deciding unit 23 decides the content (driver assistance method) of the driver assistance that is appropriate for the driver of the vehicle, based on the perceptual risk estimate (PRE) computed by the computation unit 22. The content of the driver assistance that is decided is suitable for the perceptions of the driver. The details of the method of deciding the driver assistance content will be described later. The execution unit 24 assists the driver of the vehicle in driving, in accordance with the content of the driver assistance decided by the deciding unit 23.

Control

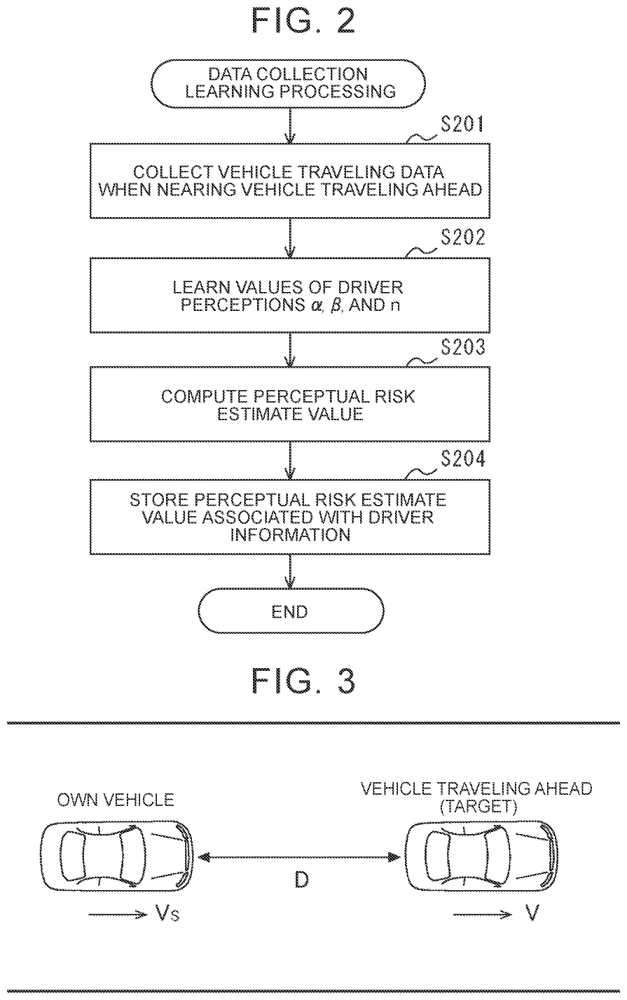

Next, processing executed by the driver assistance device 20 according to the present embodiment will be described with reference to FIGS. 2 to 5. The processing executed by the driver assistance device 20 includes data collection learning processing and driver assistance processing.

(1) Data Collection Learning Processing

FIG. 2 is a flowchart showing procedures of the data collection learning processing executed by the collection unit 21 and the computation unit 22 of the driver assistance device 20. The data collection learning processing exemplified in FIG. 2 is executed by detecting a target such as a vehicle traveling ahead in the direction of travel of the own vehicle, for example.

Step S201

The collection unit 21 of the driver assistance device 20 collects vehicle traveling data when the own vehicle nears the vehicle traveling ahead and the driver begins an act of decelerating (when nearing the vehicle traveling ahead). This act of decelerating is an act of the driver of the own vehicle interrupting the shortening of the distance to the vehicle traveling ahead, and includes acts such as an act of depressing a brake pedal, an act of releasing an accelerator pedal, an act of shifting gears down to apply engine braking, and so forth. The vehicle traveling data that is collected includes at least a speed Vs of the own vehicle, a relative speed Vr of the vehicle traveling ahead as to the own vehicle, a relative acceleration or deceleration Ar of the vehicle traveling ahead as to the own vehicle, and a distance D in the front-rear direction between the own vehicle and the vehicle traveling ahead. FIG. 3 is a diagram illustrating an example of a relation of distance and speed between the own vehicle traveling on a road and the vehicle traveling ahead (target) and moving in the same direction as the own vehicle. The vehicle traveling data may be, for example, data of instantaneous values when the vehicle starts decelerating, or may be average values for a predetermined period after the vehicle starts decelerating. After the vehicle traveling data is collected when nearing the vehicle traveling ahead, the processing advances to step S202.

Step S202

The computation unit 22 of the driver assistance device 20 learns the contents of driving operations (driving characteristics, driving perceptions) of the driver of the own vehicle, using the vehicle traveling data for when nearing the vehicle traveling ahead that has been collected by the collection unit 21. The computation unit 22 according to the present embodiment learns each of a speed perception a of the driver, an acceleration or deceleration perception R of the driver, and a perception n of the driver regarding prediction of distance in the front-rear direction. The speed perception a of the driver can be said to be a parameter that expresses the difference between the perception of the driver with respect to the speed of the own vehicle, and reality. The acceleration or deceleration perception R of the driver can be said to be a parameter that expresses the difference between the perception of the driver with respect to the relative acceleration or deceleration of the own vehicle and the vehicle traveling ahead, and reality. The perception n of the driver regarding prediction of distance in the front-rear direction can be said to be a parameter that expresses the difference between the estimation of the driver regarding the distance in the front-rear direction between the own vehicle and the vehicle traveling ahead, and reality.

Each parameter of these perceptions α, β, and n of the driver is obtained as a parameter of the individual driver of the own vehicle, based on a correlation between the distance between the vehicles and time-to-collision (TTC), a correlation between the distance between the vehicles and the relative speed, a correlation between the distance between the vehicles, speed, and timing of starting braking, and so forth. These correlations can be obtained by, for example, being measured by experimental driving by test drivers or the like, being estimated by performing simulations, and so forth.

The computation unit 22 updates the values of the perceptions α, β, and n of the driver with new values obtained from the vehicle traveling data collected in the above step S201 when nearing the vehicle traveling ahead, as learned values. When the values of the perceptions α, β, and n of the driver are learned, the processing then advances to step S203.

Step S203

The computation unit 22 of the driver assistance device 20 computes the perceptual risk estimate value (PRE value) according to Expression 1 below, using the value of the speed perception a of the driver, the value of the acceleration or deceleration perception R of the driver, and the value of the perception n of the driver regarding prediction of distance in the front-rear direction, which are learned and updated in the above step S202. When the perceptual risk estimate value (PRE value) is computed, the processing then advances to step S204.

$$PRE = \frac{Vr + α Vs + β Ar}{{D}^{n}} \qquad ( Expression 1 )$$

Step S204

The computation unit 22 of the driver assistance device 20 stores the perceptual risk estimate value (PRE value) that is newly computed in the above step S203 in predetermined memory or the like of the driver assistance device 20, associated with the information of the driver who performed the deceleration action of the vehicle this time. Note that the identity of the driver of the vehicle can be identified by using a well-known determination method such as, for example, determination by a unique ID of an electronic key carried by the driver, determination by adjusted driving (seat) position, determination by image analysis using a driver camera, and so forth. Upon the perceptual risk estimate value (PRE value) being stored in association with the driver information that can identify the individual, this data collection learning processing ends.

(2) Driver Assistance Processing

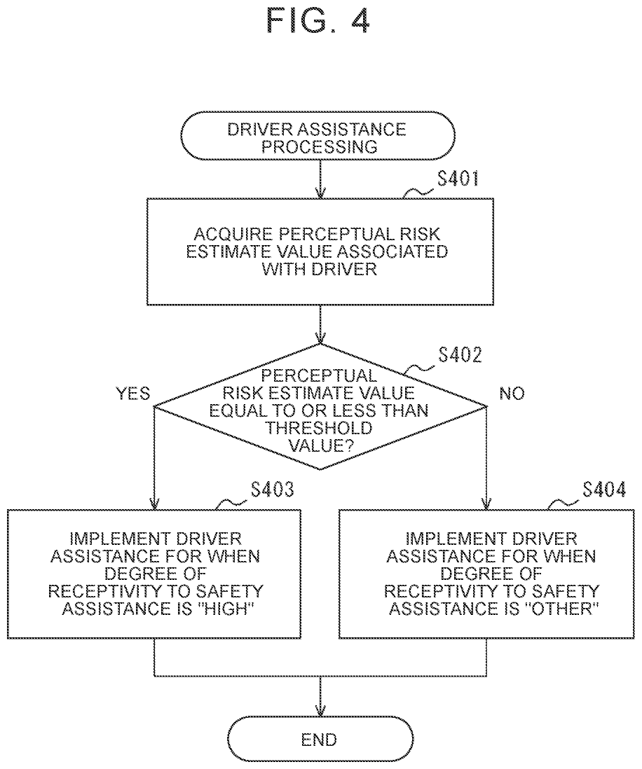

FIG. 4 is a flowchart showing procedures of the driver assistance processing executed by the deciding unit 23 and the execution unit 24 of the driver assistance device 20. The driver assistance processing exemplified in FIG. 4 is executed by detecting a target such as a vehicle traveling ahead in the direction of travel of the own vehicle, for example.

Step S401

The deciding unit 23 of the driver assistance device 20 acquires the perceptual risk estimate value (PRE value) stored in association with the information of the driver from the predetermined memory or the like. Identification of the individual driver of the vehicle is performed as described above. Note that in a situation in which the same driver drives one entire trip from ignition on (IG-ON) to ignition off (IG-OFF) of the vehicle, each time the perceptual risk estimate value (PRE value) is computed in step S203 in the data collection learning processing described above, a newly-computed perceptual risk estimate value (PRE value) is acquired in the deceleration action of the vehicle performed next time. Upon the perceptual risk estimate value (PRE value) associated with the driver of the vehicle being acquired, the processing advances to step S402.

Step S402

The deciding unit 23 of the driver assistance device 20 judges whether the perceptual risk estimate value (PRE value) acquired in the above step S401 is high or low. As an example, the deciding unit 23 can judge whether the perceptual risk estimate value (PRE value) is high or low depending on whether the perceptual risk estimate value (PRE value) is greater than a threshold value M that is set in advance. This threshold value M can be appropriately set, based on statistical results and so forth of driving data obtained from a great number of drivers.

When the perceptual risk estimate value (PRE value) is equal to or less than the threshold value M (YES in step S402), determination is made that the degree of receptivity of the driver to safety assistance is high, and the processing advances to step S403. On the other hand, when the perceptual risk estimate value (PRE value) is greater than the threshold value M (NO in step S402), determination is made that the degree of receptivity of the driver to safety assistance is not high, and the processing advances to step S404.

Step S403

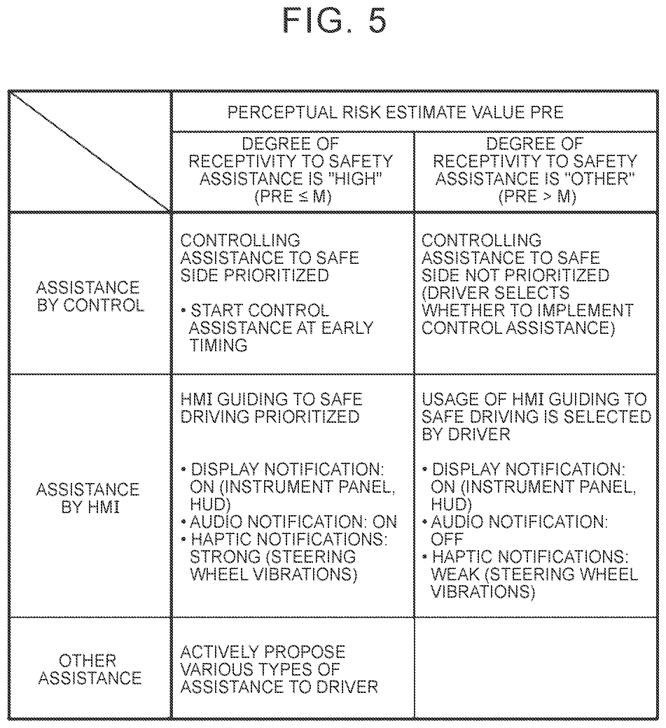

The deciding unit 23 of the driver assistance device 20 decides to perform driver assistance when the perceptual risk estimate value (PRE value) is equal to or less than the threshold value M (PRE≤M), as driver assistance to be applied to the driver of the vehicle. That is to say, in this case, driver assistance is decided to be performed for a driver who has a “high” degree of receptivity to safety assistance. The execution unit 24 of the driver assistance device 20 then carries out the driving assistance decided by the deciding unit 23 with respect to the driver of the vehicle. The left column in FIG. 5 exemplifies the contents of driver assistance for the driver when the degree of receptivity to safety assistance is “high”.

In the present embodiment, when the degree of receptivity to safety assistance is “high”, assistance for performing control for guiding the vehicle to a safe side (i.e., control related to vehicle safety) is carried out with higher priority over assistance for performing other control. More specifically, for example, control assistance is started at an earlier timing, control is performed with an increased amount of assistance (stronger effects), as compared to standard (default) settings or the degree of receptivity to safety assistance being “other”, and so forth.

Further, when the degree of receptivity to safety assistance is “high”, assistance by the HMI for guiding to safe driving (i.e., control related to vehicle safety) is performed with higher priority over other assistance by the HMI. Examples of typical assistance by the HMI that is realized when “high” include using the HMI control unit 31 to control display notification via the instrument panel, the HUD, or the like, to on, controlling audio notification via the speakers or the like to on, strongly controlling haptic notifications by vibrating the steering wheel using the steering control unit 33, and so forth.

In addition to the assistance by the HMI described above, control may be performed so that various types of safety-related assistance are actively proposed to the driver of the vehicle when this degree of receptivity to safety assistance is “high”.

Upon the driver assistance being carried out with regard to the driver when the degree of receptivity to the safety assistance is “high”, this driver assistance processing ends.

Step S404

The deciding unit 23 of the driver assistance device 20 decides to perform driver assistance when the perceptual risk estimate value (PRE value) is greater than the threshold value M (PRE>M), as driver assistance to be applied to the driver of the vehicle. That is to say, in this case, driver assistance is decided to be performed for a driver that falls under “other”, and does not have a high degree of receptivity to safety assistance. The execution unit 24 of the driver assistance device 20 then carries out the driving assistance decided by the deciding unit 23 with respect to the driver of the vehicle. The right column in FIG. 5 exemplifies the contents of driver assistance for the driver when the degree of receptivity to safety assistance is “other”.

In the present embodiment, when the degree of receptivity to safety assistance is “other”, assistance for performing control for guiding the vehicle to the safe side (i.e., control related to vehicle safety) is not carried out with higher priority over assistance for performing other control. More specifically, for example, control assistance is started at a later timing, control is performed with a reduced amount of assistance (weaker effects), as compared to standard (default) settings or the degree of receptivity to safety assistance being “high”, and so forth. Also, when the degree of receptivity to safety assistance is “other,” the driver of the vehicle is able to optionally select whether to implement control assistance to guide the vehicle to the safe side.

Also, when the degree of receptivity to safety assistance is “other”, assistance by the HMI for guiding to safe driving (i.e., control related to vehicle safety) is not performed with higher priority over other assistance by the HMI. More typically, the use of assistance by the HMI to guide to safe driving can be optionally selected by the driver of the vehicle. Examples of typical assistance by the HMI that is realized when “other” include using the HMI control unit 31 to control display notification via the instrument panel, the HUD, or the like, to on, controlling audio notification via the speakers or the like to off, weakly controlling haptic notifications by vibrating the steering wheel using the steering control unit 33, and so forth.

Upon the driver assistance being carried out with regard to the driver when the degree of receptivity to the safety assistance is “other”, this driver assistance processing ends.

The data collection learning processing (steps S201 to S204) and the driver assistance processing (steps S401 to S404) described above enables realization of carrying out driver assistance based on contents that prioritize safety and that are suitable in accordance with the driving characteristics of the driver of the vehicle.

Further, an example has been described in the present embodiment in which the driver assistance contents based on the perceptual risk estimate value (PRE value) are categorized into two situations, i.e., when the degree of receptivity to safety assistance is “high” and when “other”. However, in addition to this categorization example, the driver assistance contents may be categorized into three or more categories based on differences in the driving types of drivers, obtained by learning perceptions of the drivers, and so forth, for example.

### Operations and Effects

As described above, according to the driver assistance device of an embodiment of the present disclosure, in a situation in which a target such as a vehicle traveling ahead is present in the direction of travel of the own vehicle, collection of a distance in the front-rear direction between the own vehicle and the vehicle traveling ahead, a speed of the own vehicle, a relative speed of the vehicle traveling ahead as to the own vehicle, and a relative acceleration or deceleration of the vehicle traveling ahead as to the own vehicle, is performed when the own vehicle nears the vehicle traveling ahead and the driver performs an act of deceleration. This collected data is then used to learn each parameter of the speed perception a of the driver, the acceleration or deceleration perception R of the driver, and the perception n of the driver regarding prediction of distance in the front-rear direction. The perceptions of distance and speed held by the driver are then estimated with respect to the actual distance and speed based on the parameters obtained by this learning, and the perceptual risk estimate value (PRE value) unique to the driver of the vehicle is computed.

Assisting driving operations of the driver using the perceptual risk estimate value (PRE value) computed in this way enables driver assistance that prioritizes safety and that is suitable in accordance with the driving characteristics (driving perceptions) of the driver of the vehicle to be provided. This enables the driver to be kept from feeling uneasy or annoyed by uniform driver assistance in conventional arrangements, and to keep receptivity to the driver assistance functions by the driver from falling.

Although an embodiment of the present disclosure has been described above, the present disclosure can be understood as being a driver assistance device, a method executed by a driver assistance device including a processor and memory, a control program for executing this method, a computer-readable non-transitory storage medium that stores the control program, and a vehicle equipped with the driver assistance device.

The driver assistance device and so forth according to the present disclosure are usable in vehicles and the like, and are useful when providing suitable driver assistance in accordance with the driving characteristics of the driver of the vehicle, and so forth, are desired.

What is claimed is:

1. A driver assistance device for a vehicle, the driver assistance device comprising one or more processors configured to:
compute a perceptual risk estimate value indicating a characteristic of driving operations of a driver of the vehicle when the vehicle nears a target present in a direction of travel of the vehicle and the driver performs deceleration;
decide a driver assistance method to be applied to the driver based on the perceptual risk estimate value that is computed; and
execute the driver assistance method that is decided.

2. The driver assistance device according to claim 1, wherein the one or more processors are configured to compute the perceptual risk estimate value of the driver, based on a distance in a front-rear direction between the vehicle and the target, a perception of the driver regarding the distance in the front-rear direction, a speed of the vehicle, a relative speed between the vehicle and the target, relative acceleration or deceleration between the vehicle and the target, a perception of the driver regarding the speed, and a perception of the driver regarding the relative acceleration or deceleration.

3. The driver assistance device according to claim 2, wherein a value learned during actual travelling of the vehicle is used for the perception of the driver.

4. The driver assistance device according to claim 3, wherein the one or more processors are configured to set the perceptual risk estimate value of the driver, based on the distance in the front-rear direction between the vehicle and the target, the perception of the driver regarding the distance in the front-rear direction, the speed of the vehicle, the relative speed between the vehicle and the target, the relative acceleration or deceleration between the vehicle and the target, the perception of the driver regarding the speed, and the perception of the driver regarding the relative acceleration or deceleration, according to Expression 1 below,
$$PRE = \frac{Vr + α Vs + β Ar}{{D}^{n}}$$
where PRE is the perceptual risk estimate value of the driver, D is the distance in the front-rear direction between the vehicle and the target, n is the perception of the driver regarding the distance in the front-rear direction, Vs is the speed of the vehicle, Vr is the relative speed between the vehicle and the target, Ar is the relative acceleration or deceleration between the vehicle and the target, a is the perception of the driver regarding the speed, R is the perception of the driver regarding the relative acceleration or deceleration.

5. The driver assistance device according to claim 1, wherein the one or more processors are configured to decide, when the perceptual risk estimate value is equal to or less than a predetermined threshold value, the driver assistance method in which control related to safety of the vehicle is performed with higher priority over other control.

6. The driver assistance device according to claim 1, wherein the one or more processors are configured to decide, when the perceptual risk estimate value is greater than a predetermined threshold value, the driver assistance method in which control related to safety of the vehicle is not performed with higher priority over other control.

7. The driver assistance device according to claim 1, wherein the one or more processors are configured to:
decide the driver assistance method such that the driver assistance method includes an assistance by a human-machine interface when the perceptual risk estimate value is equal to or less than a predetermined threshold value; and
decide the driver assistance method based on a selection of the driver whether the driver uses the assistance by the human-machine interface when the perceptual risk estimate value is greater than a predetermined threshold value.

8. A method executed by a computer of a driver assistance device of a vehicle, the method comprising:
computing a perceptual risk estimate value indicating characteristic of driving operations of a driver of the vehicle when the vehicle nears a target present in a direction of travel of the vehicle and the driver performs deceleration;
deciding a driver assistance method to be applied to the driver based on the perceptual risk estimate value; and
executing the driver assistance method.

9. A non-transitory storage medium storing instructions that are executable by one or more processors and that cause the one or more processors to perform functions comprising:
computing a perceptual risk estimate value indicating characteristic of driving operations of a driver of a vehicle when the vehicle nears a target present in a direction of travel of the vehicle and the driver performs deceleration;
deciding a driver assistance method to be applied to the driver based on the perceptual risk estimate value; and
executing the driver assistance method.

10. A vehicle comprising the driver assistance device according to claim 1.
